(19) United States
(12) Patent Application Publication
(10) Pub. No.: US 2011/0200722 A1
(43) Pub. Date: Aug. 18, 2011

(54) Freshness-keeping liquid

(76) Inventor: Seiei Kohara, Asahi-shi (JP)

(21) Appl. No.: 12/656,889

(22) Filed: Feb. 18, 2010

(51) Int. Cl. A23L 3/37; A23L 3/3454

(52) U.S. Cl. 426/310; 426/615; 426/327; 426/639

(57) ABSTRACT

A liquid composition obtained by natural fermentation of a composition comprising the following (A), (B), (C) and (D) so that the mass ratio of (A)/(B)/(C)/(D) is 100/250-300/10-20/200-250:

(A) a mixture of water and calcined shell powder,
(B) a non-spore bearing plant,
(C) a spore bearing plant, and
(D) salt.

### BACKGROUND OF THE INVENTION

1. Field of the Invention

The present invention relates to a liquid composition used for keeping food fresh, and a method for keeping food fresh.

2. Description of Related Art

At times of good harvest, food, especially perishable food often is disposed of in order to adjust the price and shipment volume. At times of poor harvest, the price soars. Against such a circumstance, methods for long-term preservation of perishable food in a fresh condition have been considered for its stable supply. Examples of known methods for such long-term preservation include, in addition to frozen storage,

a method for keeping the freshness of food and food materials, comprising

coating the inside of a refrigerator housing intended to preserve food and food materials with a far-infrared emitting substance and a heating material separately or as a mixture of them,

installing an electrode to be used as a conductor in the refrigerator housing,

making the heating material generate heat to induce far-infrared radiation, and

retaining heat inside the refrigerator housing via the far-infrared radiation while adjusting a heat-retaining temperature inside the refrigerator housing to a given value (see JP-A 2004-41047);

a method for preservation of perishable food, comprising

soaking perishable food, such as raw sea urchin treated with alum, raw shrimp and mackerel, with a solution containing 56.9 wt. % of water, 40 wt. % of glycerol, 8 wt. % of sodium lactate, 0.1 wt. % of potassium chloride, 2 wt. % of sodium dihydrogenphosphate and 1 wt. % of catechin, and

cooling the perishable food to a refrigerated or frozen state (see JP-A 2004-65053); and

a method for preservation of perishable food, comprising

placing perishable food in a cylindrical container, and

spraying therein a curing foamable liquid that turns into expanded resin material through foaming and curing after sprayed, to make the perishable food embedded into the expanded resin material (see JP-A 2002-262765).

However, since the above-mentioned conventional methods for keeping perishable food fresh have an insufficient freshness-keeping effect, or require expensive and complicated devices, these methods have been far from practical use. In addition, the use of synthetic additives or chemicals may do harm to humans and the environment. Meanwhile, the frozen storage may cause freeze denaturation, such as deterioration of proteins and lipids, and also poses a problem such as drip loss during frozen storage and a thawing process.

### BRIEF SUMMARY OF THE INVENTION

An object of the present invention is to provide an industrially advantageous liquid composition which keeps perishable food fresh and is safe to use , and a method for keeping food fresh.

The present inventor conducted intensive research to achieve the above-mentioned object. As a result, he found that food can be kept fresh by contact with a liquid composition obtained by natural fermentation of a composition comprising a mixture of water and calcined shell powder; a non-spore bearing plant; a spore bearing plant; and salt, or grain vinegar and sugar at a given mass ratio, followed by freezing. The present inventor conducted further research and completed the present invention.

Namely, the present invention provides the following liquid compositions and methods for keeping food fresh.

1. A liquid composition obtained by natural fermentation of a composition comprising the following (A), (B), (C) and (D) so that the mass ratio of (A)/(B)/(C)/(D) is 100/250 to 300/10 to 20/200 to 250:
(A) a mixture of water and calcined shell powder,
(B) a non-spore bearing plant,
(C) a spore bearing plant, and
(D) salt.
2. A method for keeping food fresh, comprising a step of bringing food into contact with a liquid composition, and a subsequent step of freezing the food, the liquid composition being obtained by natural fermentation of a composition comprising the following (A), (B), (C) and (D) so that the mass ratio of (A)/(B)/(C)/(D) is 100/250-300/10-20/200-250:
(A) a mixture of water and calcined shell powder,
(B) a non-spore bearing plant,
(C) a spore bearing plant, and
(D) salt.
3. The method according to the above 2, wherein bringing food into contact with a liquid composition is achieved by soaking the food in the liquid composition.
4. The method according to the above 2, wherein the freezing is performed at a temperature of −50 to −10° C.
5. A liquid composition obtained by natural fermentation of a composition comprising the following (A), (B), (C), (E) and (F) so that the mass ratio of (E)/(A)/(B)/(C)/(F) is 100/20 to 40/250 to 300/0.2 to 0.4/30 to 50:
(A) a mixture of water and calcined shell powder,
(B) a non-spore bearing plant,
(C) a spore bearing plant,
(E) grain vinegar, and
(F) sugar.
6. A method for keeping food fresh, comprising a step of bringing food into contact with a liquid composition, and a subsequent step of freezing the food, the liquid composition being obtained by natural fermentation of a composition comprising the following (A), (B), (C), (E) and (F) so that the mass ratio of (E)/(A)/(B)/(C)/(F) is 100/20-40/250-300/0.2-0.4/30-50:
(A) a mixture of water and calcined shell powder,
(B) a non-spore bearing plant,
(C) a spore bearing plant,
(E) grain vinegar, and
(F) sugar.
7. The method according to the above 6, wherein bringing food into contact with a liquid composition is achieved by soaking the food in the liquid composition.
8. The method according to the above 6, wherein the freezing is performed at a temperature of −50 to −10° C.
9. Food which is kept fresh by contact with the liquid composition according to the above 1 or 5.

The liquid composition of the present invention is useful as a freshness-keeping composition for food, in particular perishable food etc. When a material of food products (hereinafter sometimes referred to as a food material) has been subjected to the method for keeping food fresh according to the present invention, the food material can be prevented from deteriorating in quality over a long period of time, and its storage period can be extended. Thanks to such prevention of quality deterioration, the food material can be prevented from subsequent decomposition, and accordingly odor development can also be inhibited. Further, drip loss resulting from cell disruption triggered by temperature difference between the surface and the inside of a food material during thawing, and deterioration in flavor can be reduced. For these reasons , when a food material has been subjected to the method for keeping food fresh according to the present invention and then kept in frozen storage, the food material can be thawed out without loss of the original flavor that it has before freezing. Further, no drip loss is observed, in other words, fluid can be prevented from oozing from the food material etc. Thus, the moisture retention, freshness, color, texture, etc. of the food material can be optimally maintained. The method for keeping food fresh according to the present invention can be also expected to produce inhibitory effects on freezing-induced dryness and freezer burn.

Even when food having been subjected to the method for keeping food fresh according to the present invention is thawed and refrozen, the frozen condition remains almost the same as before refreezing. Thus, the freshness of the food can be kept even after refreezing. Therefore, at times of good harvest, by use of the method for keeping food fresh according to the present invention to treat food materials , immediate processing of food materials is made unnecessary, and scheduled production is made possible.

Since the liquid composition of the present invention is made of natural substances harmless to humans, the liquid composition is safe to use.

### DETAILED DESCRIPTION OF THE INVENTION

Firstly, the liquid composition of the present invention will be illustrated. The (A) or mixture used for the liquid composition of the present invention can be prepared by mixing water and calcined shell powder. Here, calcined shell powder may be added to water before mixing, or water may be added to calcined shell powder before mixing. The ratio of water and calcined shell powder may be usually about 0.05 mg to 1 g, and preferably about 0.08 to 0.12 mg of calcined shell powder relative to 1 L of water.

The mixing can be performed by a known method such as stirring. The water used for the mixture is not particularly limited as long as it can be used for food. Examples of the water include purified water, tap water, well water, oxygen water, hydrogen water, mineral water, hot spring water and springwater. Examples of the shells include surf clams, scallops, oysters, short-necked clams, common orient clams, akoya pearl oysters and red ark shell clams. The shells also include coral and the nacre of pearls. The calcined shell powder may be obtained by calcining unprocessed shells before pulverizing, or by calcining pulverized shells. The calcining temperature is usually about 800 to 2000° C., and preferably about 1000 to 1500° C. The pulverizing method may be a known method, for example, a method using a mixer, a mill, a roll crusher or a pin mill, and a method using a grinder such as a tiltable-type rotary barrel finishing machine. The calcined shell powder may also be a commercially available calcined shell calcium etc. Preferable examples of the commercially available calcined shell calcium include Surf clam Ca (manufactured by Mizumoto Co., Ltd.) and Surfcera (manufactured by Surfcera Co., Ltd.) . The mixture of water and calcined shell powder can be used as it is, but may be used after it is rendered alkaline, preferably adjusted at about pH 7.5 to 9.9. The pH can be adjusted using a pH adjuster. Preferred is a pH adjuster that can be used as a food additive, and examples thereof include trisodium citrate, citric acid, lactic acid, L-tartaric acid, potassium carbonate, sodium bicarbonate, sodium carbonate, dipotassium hydrogen phosphate, potassium dihydrogen phosphate and acetic acid.

The (B) or non-spore bearing plant is preferably an edible plant that does not propagate itself by means of spores, and examples thereof include onions, ginger, beefsteak plants, eggplants, carrots, beefsteak plants and parsley. These plants may be used in a raw unheated state. These plants are preferably used as pieces with a side about 3 to 5 mm in length, for example.

The (C) or spore bearing plant may be terrestrial or aquatic as long as it propagates itself by means of spores, but an aquatic spore bearing plant is preferred. Examples of the terrestrial spore bearing plant include shiitake mushroom, maitake mushroom, enokitake mushroom, shimeji mushroom and king oyster mushroom. Examples of the aquatic spore bearing plant include sea tangle, wakame seaweed, gulfweed, sea trumpet, arame seaweed and Petalonia binghamiae. These plants are preferably in a dry state. These plants are preferably used as pieces with a side about 3 to 5 mm in length, for example.

The (D) or salt is not particularly limited as long as it is edible, but natural salt is preferred. Examples of the natural salt include natural sea salt and rock salt, and more preferred is natural sea salt containing about 95 mass % or more, and preferably about 98 mass % or more of sodium chloride.

Examples of such natural sea salt include salt that is produced through spontaneous evaporation in the Guerrero Negro salt pans in the Baja California peninsula in the Mexico region. The natural salt may be subjected to removal of water or other contents in the salt crystal, for example, under reduced pressure.

Examples of the (E) or grain vinegar include rice vinegar and grain vinegar made from any other grain than rice, such as wheat, barley, rice, sake lees and corn, as a main raw material.

Examples of the (F) or sugar include white sugar, brown sugar, unrefined brown sugar and coarse granulated sugar.

The liquid composition of the present invention can be produced according to the following steps:

Step 1: a step of preparing a composition by mixing at least. the above-mentioned (A), (B), (C) and (D), or by mixing at least the above-mentioned (A), (B), (C), (E) and (F), and

Step 2: a step of natural fermentation of the composition prepared in the above Step 1.

As for the proportion (mass ratio) of (A), (B), (C) and (D) in Step 1, (A)/(B)/(C)/(D) is preferably about 100/260-270/15-18/230-240. As for the proportion (mass ratio) of (A), (B), (C), (E) and (F), (E)/(A)/(B)/(C)/(F) is preferably about 100/25-35/260-270/0.25-0.35/35-40. The liquid composition prepared in either of the above-mentioned mass ratios is suitable for keeping food fresh. The mixing can be performed by a known method, for example, by use of a mixing machine such as a mixer and a homomixer.

The natural fermentation in Step 2 is preferably performed at an ambient (or natural) temperature, which is usually about 5 to 30° C., and preferably 20 to 25° C. The fermentation is preferably allowed to continue until transparency following white bubble generation is observed in the composition. The fermentation period varies with temperature, humidity, etc., but is usually about 5 to 30 days, and preferably about 10 to 15 days.

The naturally fermented liquid composition may be used as it is, or may be used after filtered using filter media such as cloth and filter.

If needed, various additives commonly used in the food industry field, such as organic acids, antioxidants, alcohols, sweeteners, preservatives, emulsifiers, thickening stabilizers, nutritional enrichment ingredients including vitamins, spices, enzymes, pH adjusters, seasonings, colorants and brighteners may be used in combination with the liquid composition of the present invention to the extent that they do not impair the effect of the liquid composition. Also, if needed, these additives may be appropriately added to the liquid composition of the present invention.

Examples of the organic acid include ascorbic acid, sodium ascorbate, erythorbic acid, sodium erythorbate, potassium citrate, sodium citrate and sodium malate.

Examples of the antioxidant include natural extracts such as apple extract, dokudami extract (Houttuynia cordata extract), blueberry leaf extract, rice bran oil extract, gallic acid, ellagic acid, catechin and proanthocyanidin; organic acids such as erythorbic acid, citric acid esters and sodium erythorbate; vitamins such as vitamin C and vitamin E; and sodium edetate.

Examples of the alcohol include ethanol, whether synthetic or fermentative, and the like.

Examples of the sweetener include sorbit, glucose, saccharin, saccharin sodium, aspartame, xylitol, sodium glycyrrhizinate, stevia, monosaccharides, disaccharides and oligosaccharides.

Examples of the preservative include natural extracts such as milt proteins and polylysine, sorbic acid and potassium sorbate.

Examples of the emulsifier include natural extracts such as saponin, soybean saponin and lecithin, glycerol esters, sucrose esters, sorbitan esters and propylene glycol esters.

Examples of the thickening stabilizer include polysaccharides such as guar gum, tara gum, gum arabic, curdlan and xanthan gum; seaweed extracts such as carrageenan and alginic acid; shell extracts such as chitin and chitosan; plant extracts such as pectin; and dextran.

Examples of the nutritional enrichment ingredient include vitamins such as vitamin A, vitamin B₂, vitamin B₆, vitamin C and vitamin E; calcium salts such as calcium citrate and calcium carbonate; ferric salts such as ferric chloride and ferric citrate; and amino acids such as leucine, theanine and glutamic acid.

Examples of the spice include spices made from pepper, sesame, mentha herb, basil, garlic or oregano as a raw material.

Examples of the enzyme include amylase, catalase, tannase, papain, protease, lactic acid bacteria, glucose oxidase and glucose transferase.

Examples of the pH adjuster include trisodium citrate, citric acid, lactic acid, L-tartaric acid, potassium carbonate, sodium bicarbonate, sodium carbonate, dipotassium hydrogen phosphate, potassium dihydrogen phosphate and acetic acid.

Examples of the seasoning include amino acids such as asparagine and valine; nucleic acids such as sodium inosinate and ribonucleotide calcium; mirin (sweet cooking sake); vinegar; miso (fermented soybean paste); yeast extract; and kelp extract.

Examples of the colorant include natural extracts such as annatto, gardenia, carotinoid, anthocyanin and flavonoid; metals such as aluminum powder, gold and silver; red No. 2; red No. 40; yellow No. 4; yellow No. 5; green No. 3; blue No. 1; and iron chlorophyll.

The preferable amount of each of the above-mentioned various additive ingredients in the liquid composition are such that an effective amount of the additive may be present in such a freshness-keeping liquid composition when food is brought into contact with the liquid composition in order to be kept fresh.

The liquid composition of the present invention can be used as a freshness-keeping composition for food, particularly perishable food, for example, fish and shellfish (for example, saltwater fish such as arabesque greenling, bonito, slender sprat, japanese shad, double-lined fusilier, spanish mackerel, horse mackerel, mackerel, tuna, anchovy, saury, sea bream, olive flounder, righteye flounder, flying fish, squid, firefly squid, shrimp, scallop, young conger eel, crab, dolphinfish, sea urchin, whale, dolphin and shark; and freshwater fish such as carp, crucian carp, loach and eel), meat (for example, beef, pork, chicken, mutton, etc.), vegetables (for example, carrots, parsley, beefsteak plant leaves, cucumbers, potatoes, onions, etc.), fruits (for example, cherries, prunes, pineapples, coral, pears, peaches, etc.) and the like. The above-mentioned food may be used in the form of a whole or part thereof. The part thereof is any part without limitation, and may be entrails such as liver, intestine, stomach, ovary, heart and milt. The liquid composition of the present invention can be used in a method for keeping the above-mentioned food fresh.

Secondly, the method for keeping food fresh according to the present invention will be illustrated. The method for keeping food fresh comprises the following steps:

Step a: a step of bringing food into contact with the liquid composition of the present invention; and

Step b: a step of, following Step a, freezing the food having been brought into contact with the liquid composition.

In Step a, the method of bringing food into contact with the liquid composition of the present invention may be, for example, a method in which food is soaked in the liquid composition, a method in which the liquid composition is applied on, sprayed on or injected into food, or other methods. The contact period varies with the kind of food, the size thereof , contact method therefor, etc. For example, when a fillet (weighing about 150 to 250 g) of a fresh fish is soaked, the soaking period is usually about 3 seconds to 10 minutes, and preferably about 3 seconds to 4 minutes. When the soaking period is within the above-mentioned range, the freshness-keeping effect is sufficiently produced and the fillet does not become too much salty. After soaked in the liquid composition, food may be subjected to the following step as it is, or may be washed with water, salt water, etc. before the following step.

In Step b, the temperature for freezing the food is usually about −50 to −10° C., and preferably −45 to −30° C. According to the present invention, food can be kept fresh even if it is frozen at a relatively high temperature of about −10° C. The freezing period is preferably about 12 to 24 hours . Subsequently, the food may be kept in frozen storage at a temperature of −50° C. or lower. Fish and shellfish to be consumed fresh may be frozen at a relatively high temperature of about −10° C., but are preferably kept and frozen at about −30° C. or lower for about 24 hours or more. Subsequently, the fish and shellfish may be kept in frozen storage at a temperature of −50° C. or lower. Before freezing, fluid on the surface of the food is preferably removed with, for example, cloth, paper, etc. The food may be frozen after packed by a known method (for example, vacuum-packing etc.).

The frozen food can be kept as it is in frozen storage, and is preferably kept in frozen storage. As for thawing, the frozen food may be allowed to naturally thaw by a known method, for example, by soaking the food in water of or salt water of about 20 to 26° C. The thawed food may be even refrozen. The refreezing can be performed according to the freezing method described above.

After brought into contact with the liquid composition of the present invention, food may also be kept in refrigerated storage as it is or may be kept in dry storage. The drying method may be, for example, natural drying or artificial drying by use of heating, blowing, reduced pressure, etc.

### EXAMPLE

The present invention will be illustrated in more detail by way of the following examples, but is not limited thereto.

For use in Examples 1 and 2 (liquid compositions 1 and 2) and Comparative Examples 1 to 4 (comparative compositions 1 to 4) , the mixture of water and calcined shell powder was prepared by mixing 0.1 mg of Surfcera (manufactured by Surfcera Co., Ltd.) with 1 L of water. The salt to be used was prepared by exposing import salt crystals, which were produced through spontaneous evaporation in the Guerrero Negro salt pans in the Baja California peninsula in the Mexico region, to vacuum evaporation, followed by pulverization. The non-spore bearing plant to be used was a mixture of onions, ginger and beefsteak plant leaves (the weight ratio of onion : ginger: beefsteak plant leaf was 100:10:1). The spore bearing plant to be used was sea tangle. These ingredients were mixed in the compositional ratio shown below in Table 1, and the mixture was subjected to natural fermentation for 2 weeks at about 20° C.

In Examples 3 and 4 (liquid compositions 3 and 4) and Comparative Examples 5 to 8 (comparative compositions 5 to 8), there were used the same mixture of water and calcined shell powder and salt as in Examples 1 and 2 and Comparative Examples 1 to 4. The grain vinegar to be used was Gin-Sen (trade name) manufactured by Mizkan Group Corporation, and the sugar to be used was superfine sugar manufactured by Hadohou Co., Ltd. These ingredients were mixed in the compositional ratio shown below in Table 2, and the mixture was subjected to natural fermentation for 2 weeks at about 20° C.

### Rating of Compositions (1)

A 32 kg bigeye tuna, which was landed at the Choshi harbor early in the morning, was cut into fillets weighing about 200 g each. Then, by use of 1 L each of the above-mentioned liquid compositions and comparative compositions, fillets were separately soaked in any of the compositions for 3 minutes. After soaked, the fillets were washed with water and their surfaces were wiped dry with paper towel. Then, the fillets were vacuum-packed, frozen at −30° C., and kept at −30° C. for 10 days. 10 days later, the fillets having been kept in frozen storage were allowed to naturally thaw at room temperature (about 20° C.) . By naked eye observation, the moisture condition and drip on the surface of the thawed fillet were rated on the following criteria.

Drip: A—hardly dripping out at all, B—dripping out a little, C—dripping out

Moisture condition: A—hardly dry at all, B—a little dry, C—dry

In addition, the odor was rated by sniffing (A—hardly smelling bad, B—smelling a little bad, C—smelling fishy). Additionally, an about 15 g portion of the thawed fillet was cut out, and minced with water. The counts of aerobic bacteria and coliforms in the whole of this minced fish solution were measured using a W55000 Petrifilm (AC plate for viable cell count measurement; manufactured by SANPLATEC CO., LTD.) and a W55001 Petrifilm (CC plate for coliform count measurement; manufactured by SANPLATEC CO., LTD.). Each measurement was performed according to the product manual. Colony formation on the W55000 Petrifilm after 48 hour culture and on the W55001 Petrifilm after 24 hour culture was observed. When no colonies were observed on either of the Petrifilms after culture, the sample was rated as negative in the bacterial propagation. When one or more colonies were observed on either or both of the Petrifilms, the sample was rated as positive in the bacterial propagation.

The results are shown in Tables 1 and 2.

As for the overall rating, the bigeye tuna fillets soaked in the liquid compositions 1 to 4 obtained in Examples 1 to 4 were rated as a circle or double-circle symbol, and it is shown that these fillets had no bacterial propagation, were in a good condition in terms of drip and moisture, and retained their freshness.

TABLE 1

| | Ingredient | | | | | | | | |
|---|---|---|---|---|---|---|---|---|---|
| | Mixture of water and | | | spore bearing | Rating | | | | |
| | calcined shell | plant | salt | plant | | | moisture | | overall |
| | powder(g) | (g) | (g) | (g) | bacteria | drip | condition | odor | rating |
| liquid | 100 | 275 | 225 | 15 | A | A | A | A | ⊚ |
| composition 1 | | | | | | | | | |
| liquid | 100 | 250 | 200 | 10 | A | A | A | B | ◯ |
| composition 2 | | | | | | | | | |
| comparative | 100 | 240 | 190 | 5 | A | B | C | C | X |
| composition 1 | | | | | | | | | |
| comparative | 100 | 310 | 260 | 25 | A | C | C | C | X |
| composition 2 | | | | | | | | | |
| comparative | 100 | 100 | 150 | 5 | B | C | C | C | X |
| composition 3 | | | | | | | | | |
| comparative | 100 | 350 | 300 | 30 | A | C | C | C | X |
| composition 4 | | | | | | | | | |

Bacteria: A-negative, B-positive
Drip: A-hardly dripping out at all, B-dripping out a little, C-dripping out
Moisture condition: A-hardly dry at all. B-a little dry, C-dry
Odor: A-hardly smelling bad, B-smelling a little bad, C-smelling fishy
Overall rating: ⊚- A in all rating categories, ◯- B in at least one rating category but A in the rest, X- C in at least one rating category

TABLE 2

| | Ingredient | | | | | | | | | |
|---|---|---|---|---|---|---|---|---|---|---|
| | | Mixture of water | | spore bearing | | Rating | | | | |
| | grain | and calcined shell | plant | plant | sugar | | | moisture | | overall |
| | vinegar | powder(g) | (g) | (g) | (g) | bacteria | drip | condition | odor | rating |
| liquid | 100 | 30 | 275 | 0.3 | 40 | A | A | A | A | ⊚ |
| composition 3 | | | | | | | | | | |
| liquid | 100 | 40 | 300 | 0.4 | 50 | A | B | A | B | ◯ |
| composition 4 | | | | | | | | | | |
| comparative | 100 | 10 | 240 | 0.1 | 20 | A | B | C | C | X |
| composition 5 | | | | | | | | | | |
| comparative | 100 | 50 | 310 | 0.5 | 60 | A | C | C | C | X |
| composition 6 | | | | | | | | | | |
| comparative | 100 | 5 | 150 | 0.1 | 10 | B | C | C | C | X |
| composition 7 | | | | | | | | | | |
| comparative | 100 | 60 | 350 | 0.6 | 65 | B | C | C | C | X |
| composition 8 | | | | | | | | | | |

Bacteria: A-negative, B-positive
Drip: A-hardly dripping out at all, B-dripping out a little, C-dripping out
Moisture condition: A-hardly dry at all, B-a little dry, C-dry
Odor: A-hardly smelling bad, B-smelling a little bad, C-smelling fishy
Overall rating: ⊚- A in all rating categories, ◯- B in at least one rating category but A in the rest, X- C in at least one rating category

### Rating of Compositions (2)

In the same manner as in the above “Rating of compositions (1) ” , by use of the liquid compositions obtained in Examples 1 to 4, fillets of the bigeye tuna were each treated with a different composition, and frozen at −30° C. The fillets were kept in frozen storage at −30° C. for 10 days and then were allowed to naturally thaw at room temperature (about 20° C.) . The fillets were washed, and their surfaces were wiped dry. The fillets were vacuum-packed and kept again in frozen storage at −30° C. or lower. 10 days later, the fillets were allowed to thoroughly thaw and rated in the same manner as in Example 5. The results showed that the bigeye tuna fillets soaked in the liquid compositions 1 to 4 obtained in Examples 1 to 4 had no bacterial propagation, were in a good condition in terms of drip and moisture, and retained their freshness.

### Rating of Compositions (3)

A mackerel scad and a kimeji (young yellowfin tuna) , which were landed in Hachijo Island, were individually sliced into three parts. One fillet of each fish was soaked in the liquid composition 1 of Example 1 (MR: miracluno) for 5 minutes, and kept in the freezer (at −15° C.) . As a control, the other fillet of each fish was kept in the freezer as it was. After preserved for 1 day, each fillet was allowed to thaw and its appearance was observed. Compared with the flesh of the mackerel scad as a control, the flesh of the mackerel scad treated with the liquid composition 1 of Example 1 (MR) was glossier in whole, the skin on the backside was bluish and the skin on the abdominal side was shining white. While the dark-colored flesh of the kimeji as a control was discolored to brown, the dark-colored flesh of the kimeji treated with MR was reddish, remaining in the same color as that of the dark-colored flesh of the kimeji immediately after landed. Regarding observation of fillets, the flesh of the kimeji as a control was less glossy, while the flesh of the kimeji treated by MR was elastic, glossy and firm with sharp cut surfaces.

The above observations showed that the fillets of the mackerel scad and the kimeji each treated by MR were kept fresh.

1. A liquid composition obtained by natural fermentation of a composition comprising the following (A), (B), (C) and (D) so that the mass ratio of (A)/(B)/(C)/(D) is 100/250-300/10-20/200-250:
(A) a mixture of water and calcined shell powder,
(B) a non-spore bearing plant,
(C) a spore bearing plant, and
(D) salt.

2. A method for keeping food fresh, comprising a step of bringing food into contact with a liquid composition, and a subsequent step of freezing the food, the liquid composition being obtained by natural fermentation of a composition comprising the following (A), (B), (C) and (D) so that the mass ratio of (A)/(B)/(C)/(D) is 100/250-300/10-20/200-250:
(A) a mixture of water and calcined shell powder,
(B) a non-spore bearing plant,
(C) a spore bearing plant, and
(D) salt.

3. The method according to claim 2, wherein bringing food into contact with a liquid composition is achieved by soaking the food in the liquid composition.

4. The method according to claim 2, wherein the freezing is performed at a temperature of −50 to −10° C.

5. A liquid composition obtained by natural fermentation of a composition comprising the following (A), (B), (C), (E) and (F) so that the mass ratio of (E)/(A)/(B)/(C)/(F) is 100/20-40/250-300/0.2-0.4/30-50:
(A) a mixture of water and calcined shell powder,
(B) a non-spore bearing plant,
(C) a spore bearing plant,
(E) grain vinegar, and
(F) sugar.

6. A method for keeping food fresh, comprising a step of bringing food into contact with a liquid composition, and a subsequent step of freezing the food, the liquid composition being obtained by natural fermentation of a composition comprising the following (A), (B), (C), (E) and (F) so that the mass ratio of (E)/(A)/(B)/(C)/(F) is 100/20-40/250-300/0.2-0.4/30-50:
(A) a mixture of water and calcined shell powder,
(B) a non-spore bearing plant,
(C) a spore bearing plant,
(E) grain vinegar, and
(F) sugar.

7. The method according to claim 6, wherein bringing food into contact with a liquid composition is achieved by soaking the food in the liquid composition.

8. The method according to claim 6, wherein the freezing is performed at a temperature of −50 to −10° C.

9. Food which is kept fresh by contact with the liquid composition according to claim 1.

10. Food which is kept fresh by contact with the liquid composition according to claim 5.
